(19) United States
(12) Patent Application Publication
(10) Pub. No.: US 2020/0391673 A1
(43) Pub. Date: Dec. 17, 2020

(54) VEHICLE INTERIOR MATERIAL HAVING STITCH LINE AND METHOD OF IMPLEMENTING STITCH LINE ON VEHICLE INTERIOR MATERIAL

(71) Applicant: Dawon-eng CO., Ltd, Anyang-si (KR)

(72) Inventor: Sang Jun SEO, Anyang-si (KR)

(73) Assignee: Dawon-eng CO., Ltd, Anyang-si (KR)

(21) Appl. No.: 16/704,161

(22) Filed: Dec. 5, 2019

(30) Foreign Application Priority Data
Jun. 12, 2019 (KR) 10-2019-0069132

(51) Int. Cl. B60R 13/02

(52) U.S. Cl. CPC B60R 13/02; B32B 7/08; B32B 2605/003

(57) ABSTRACT

Disclosed are a vehicle interior material having a stitch line and a method of implementing the stitch line on the vehicle interior material. The vehicle interior material includes a base material including a plurality of protrusions on a surface thereof, and a skin configured to cover the surface of the base material and including a plurality of holes into which the protrusions are fitted to be exposed to the outside in order to form a plurality of imitation stitches, wherein the plurality of imitation stitches is arranged in a row to form a stitch line, and the base material includes a main body and a coupling member coupled to the main body and including at least one of the protrusions.

### CROSS-REFERENCE TO RELATED APPLICATION(S)

This application is based on and claims priority under 35 U.S.C. § 119 to Korean Patent Application No. 10-2019-0069132, filed on Jun. 12, 2019, in the Korean Intellectual Property Office, the present disclosure of which is incorporated by reference herein in its entirety.

### BACKGROUND

### 1. Field

The present disclosure relates to a vehicle interior material having a stitch line to enhance a decorative effect and a method of implementing the stitch line on the vehicle interior material.

### 2. Description of Related Art

There are vehicle interior materials having stitch lines to enhance a decorative effect.

A stitch line is naturally formed in a process of actually stitching a skin of interior materials, but a design thereof tends to be monotonous.

Accordingly, in recent years, in order to promote the diversity of the design of the stitch line, a method of implementing the stitch line using imitation stitches has been developed.

However, there is a concern that productivity of a vehicle interior material may be impaired in the process of forming imitation stitches of various designs on the vehicle interior material in order to implement various designs of the stitch line.

### SUMMARY

It is an aspect of the present disclosure to provide a vehicle interior material having a stitch line capable of implementing a variety of designs of the stitch line while suppressing a decrease in productivity and a method of implementing the stitch line on the vehicle interior material.

Additional aspects of the present disclosure will be set forth in part in the description which follows and, in part, will be obvious from the description, or may be learned by practice of the present disclosure.

In accordance with an aspect of the present disclosure, a vehicle interior material includes a base material including a plurality of protrusions on a surface thereof, and a skin configured to cover the surface of the base material and including a plurality of holes into which the protrusions are fitted to be exposed to the outside in order to form a plurality of imitation stitches, wherein the plurality of imitation stitches is arranged in a row to form a stitch line, and the base material includes a main body and a coupling member coupled to the main body and including at least one of the protrusions.

The coupling member may be implemented as a plurality of types such that the protrusions differ from each other in color, texture, or shape of surfaces exposed to the outside through at least the holes.

The protrusions may include a fixed protrusion integrally fixed to the main body in a process of molding the main body and a coupling protrusion provided on the coupling member to be coupled to the main body, and the fixed protrusion and the coupling protrusion may be provided to differ from each other in color, texture, or shape of surfaces exposed to the outside through at least the holes.

One combination or a plurality of combinations of the fixed protrusion and the coupling protrusion may be alternately arranged along a forming direction of the stitch line.

The coupling protrusion may be implemented as a plurality of types to differ from each other in color, texture, or shape of surfaces exposed to the outside through at least the holes.

The coupling member may further include a support portion to support the coupling protrusion, and the plurality of coupling protrusions may be integrally provided on the support portion.

At least some of the plurality of coupling protrusions provided on the support portion may be provided to differ from each other in color, texture, or shape of surfaces exposed to the outside through at least the holes.

The main body may be provided with a mounting hole formed to communicate with the hole, the coupling member may include a support portion provided to be caught around the mounting hole to support the protrusion such that the protrusion is sequentially coupled to the mounting hole and the hole in a direction from a back surface to a front surface of the main body, and the mounting hole may be filled by the protrusion.

In accordance with another aspect of the present disclosure, in a method of implementing a stitch line on a vehicle interior material in which a skin is coupled to a surface of a base material, the method includes providing a plurality of protrusions on the surface of the base material, providing a plurality of holes, into which the protrusions are fitted to be exposed to the outside in order to form imitation stitches, on the skin, and forming the stitch line through an arrangement of a plurality of the imitation stitches by coupling the skin to the surface of the base material such that the plurality of protrusions is fitted to the plurality of holes, wherein the base material includes a main body and a coupling member coupled to the main body and including at least one of the protrusions, the protrusions include a fixed protrusion integrally fixed to the main body in a process of molding the main body and a coupling protrusion provided on the coupling member to be coupled to the main body, the coupling member is implemented as a plurality of types such that the protrusions differ from each other in color, texture, or shape of surfaces exposed to the outside through at least the holes, and the types of the coupling members coupled to the main body in a state in which the main body is shared are applied differently to implement the stitch lines having a different design.

### BRIEF DESCRIPTION OF THE DRAWINGS

These and/or other aspects of the present disclosure will become apparent and more readily appreciated from the following description of the embodiments, taken in conjunction with the accompanying drawings of which:

FIG. 1 is a perspective view illustrating a structure of a vehicle interior material having a stitch line according to an embodiment;

FIG. 2 is a cross-sectional view of a main portion taken along line A-A′ in FIG. 1;

FIG. 3A is a plan view of main portions illustrating a first configuration of coupling members to which the structure of the vehicle interior material having the stitch line shown in FIG. 2 is applied;

FIG. 3B is a plan view of main portions illustrating a second configuration of coupling members to which the structure of the vehicle interior material having the stitch line shown in FIG. 2 is applied;

FIG. 3C is a plan view of main portions illustrating a third configuration of coupling members to which the structure of the vehicle interior material having the stitch line shown in FIG. 2 is applied;

FIG. 4 is a cross-sectional view of a main portion illustrating a modified example of the vehicle interior material having the stitch line according to an embodiment;

FIG. 5 is a cross-sectional view of a main portion illustrating another modified example of the vehicle interior material having the stitch line according to an embodiment; and

FIG. 6 is a cross-sectional view of a main portion illustrating another modified example of the vehicle interior material having the stitch line according to an embodiment.

### DETAILED DESCRIPTION

Hereinafter embodiments of the present disclosure will be described in detail with reference to the accompanying drawings. The embodiments described below are provided by way of example so that those skilled in the art will be able to fully understand the spirit of the present disclosure. The present disclosure is not limited to the embodiments described below, but may be embodied in other forms. In order to clearly explain the present disclosure, parts not related to the description are omitted from the drawings, and the width, length, thickness, etc. of the components may be exaggerated for convenience. Like reference numbers refer to like elements throughout this specification.

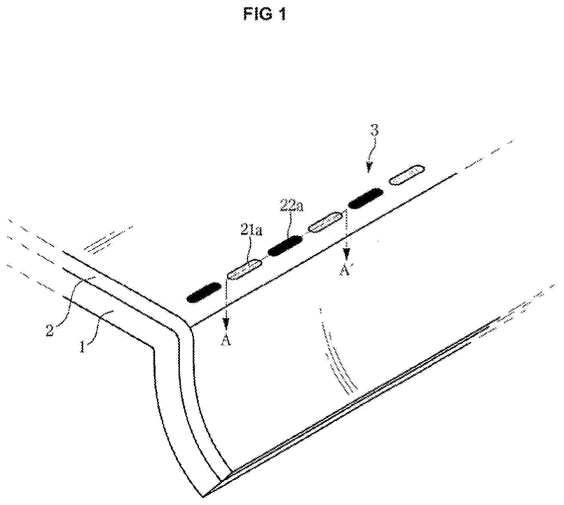

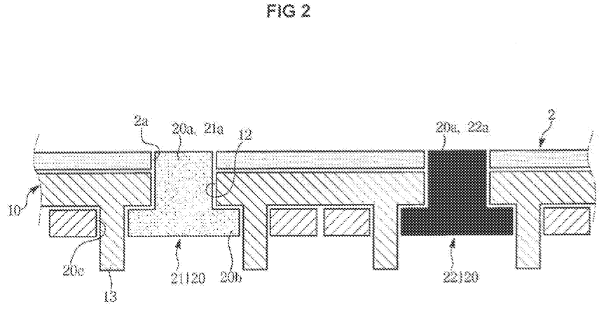

As illustrated in FIGS. 1 and 2, a vehicle interior material having a stitch line according to an embodiment includes a base material 1 and a skin 2 attached to a surface thereof.

The base material 1 is provided with a plurality of protrusions 20a, and the skin 2 is provided with a plurality of holes 2a into which the protrusions 20a are fitted to be exposed to the outside in order to form imitation stitches.

The plurality of protrusions 20a may be arranged to form a predetermined row, and the plurality of holes 2a may be arranged to coincide with the respective protrusions 20a.

Thus, a stitch line 3 is provided on a decorative surface of the vehicle interior material through an arrangement of the plurality of imitation stitches in a state where the skin 2 is attached to the base material 1 to cover the surface of the base material 1.

The base material 1 may be implemented with a variety of materials within a range capable of forming an appearance of the vehicle interior material, such as a metal and a hard resin molding material.

The skin 2 may be implemented in a variety of materials capable of providing a soft texture or touch, such as leather, artificial leather, and a flexible resin sheet.

Such a vehicle interior material may form a garnish as an example. The garnish refers to trims, instrument panels, or decorative interior parts attached to a dashboard.

In the case of a vehicle interior material forming a garnish, the base material 1 may be provided as a resin molded product that is injection molded, and the skin 2 may be provided as leather, or a resin molded product of the form of a sheet flexibly provided to produce a luxurious feel of leather.

In order to implement various designs of the stitch line 3 while suppressing a decrease in productivity of the vehicle interior material, the base material 1 includes a main body 10 and a coupling member 20 having the at least one protrusion 20a to be coupled to the main body 10.

This configuration of the base material 1 allows a plurality of vehicle interior materials with different designs of the stitch line 3 to be manufactured in a manner of selectively employing the coupling member 20 that is to be coupled to the body 10, in manufacturing the vehicle interior materials by applying the same main body 10, so that such a configuration of the base material 1 may contribute to implementation of various designs of the stitch line 3 of the vehicle interior material while suppressing a decrease in productivity of the vehicle interior material.

The main body 10 may be provided with mounting holes 12 formed at positions corresponding to the holes 2a of the skin 2 to communicate with the holes 2a, and the coupling member 20 may include a support portion 20b provided to be caught around the mounting hole 12 to support the protrusion 20a.

Therefore, the coupling member 20 is coupled in a direction from a back surface to a front surface of the main body 10 such that the protrusion 20a is sequentially coupled to the mounting hole 12 and the hole 2a, and the support portion 20b is supported on the back surface of the main body 10 around the mounting hole 12 in a state where the protrusion 20a is coupled to the mounting hole 12 and the hole 2a, thereby increasing a supporting force of the coupling member 20 with respect to the main body 10.

In order to prevent the rigidity of the main body 10 from decreasing due to the formation of the mounting holes 12, the mounting hole 12 may be completely filled by the protrusion 20a in a state where the protrusion 20a is fitted into the mounting hole 12 such that no gap is formed between the protrusion 20a and the mounting hole 12.

The coupling member 20 may be provided with fastening holes 20c formed at opposite sides of the support portion 20b, and the main body 10 may be provided with fastening portions 13 extending downward corresponding to positions of the fastening holes 20c to be fitted into the fastening holes 20c.

The coupling member 20 may be fixed to the main body 10 by fixing the support portions 20b to the main body 10 in a state where the fastening portions 13 are stably fitted to the fastening holes 20c.

The main body 10 and the coupling member 20 may be provided as a resin molded product that is injection molded, respectively, and may be fixed to each other through various methods, such as a fastening method using ultrasonic welding, thermal welding, screws, and the like, and a pressing method and a locking method, in order to prevent the movement of the coupling member 20 between the support portions 20b and the main body 10.

The coupling member 20 may be implemented as a plurality of types such that the protrusions 20a differ from each other in color, texture, or shape of the surface exposed to the outside through at least the holes 2a.

Therefore, the coupling members 20 may form imitation stitches of different designs for each type and thus a vehicle interior materials with various stitch lines may be implemented by selecting the types of coupling members 20 that are to be coupled to the main body 10 in a state where the main body 10 of the base material 1 is shared or by combining various arrangements of the coupling members 20 of different types.

Two types of the coupling members 20 may be provided by including a first coupling member 21 having a first color and a second coupling member 22 having a second color. Accordingly, a surface 21a of the protrusion 20a of the first coupling member 21 having the first color and a surface 22a of the protrusion 20a of the second coupling member 22 having the second color may have different colors, thereby implementing imitation stitches having different designs.

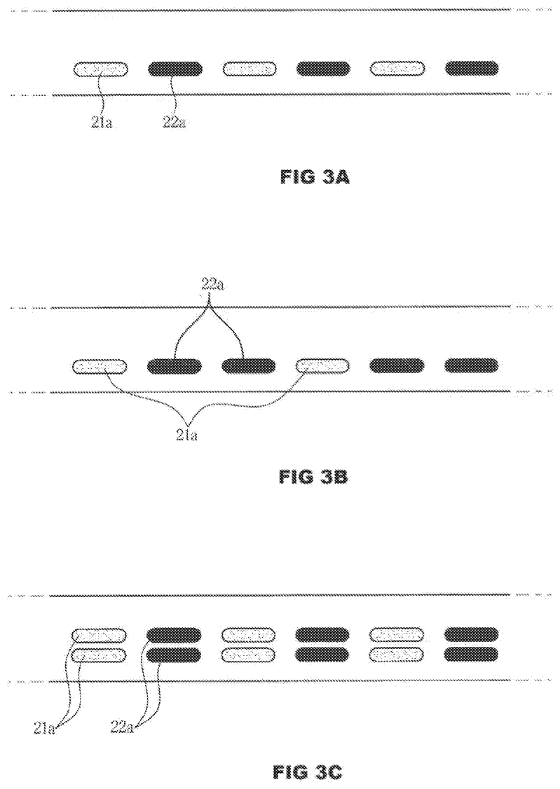

As illustrated in FIG. 3, the first coupling member 21 and the second coupling member 22 configured as above may be used to implement various designs of stitch lines in a manner in which one or more stitches are alternately arranged along the forming direction of the stitch line 3 or in a manner arranged to form a plurality of stitch lines.

Various types of the coupling members 20 may be provided such that the surfaces of the protrusions 20a exposed to the outside through the holes 2a are different in color, texture, or shape by changing the structure of the mold for injection molding, or by post-processing the surface of the protrusion 20a in the injection molded state.

In this case, various post-processing methods such as painting, hydraulic transfer, and ion plasma may be applied as a post-processing method of the surface of the protrusion 20a.

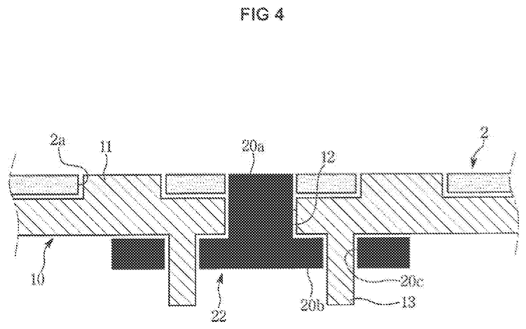

As illustrated in FIG. 4, in a modified example of the vehicle interior material according to an embodiment, protrusions forming the imitation stitches may include a fixed protrusion 11 integrally fixed the main body 10 in a process of molding the main body 10, and the coupling protrusion 20a provided on the coupling member 22 to be coupled to the main body 10.

Therefore, the stitch line may be produced to have various designs by a combination of an imitation stitch formed through the fixed protrusion 11 provided on the main body 10 and an imitation stitch formed through the coupling protrusion 20a provided on the coupling member 22.

In this case, the fixed protrusion 11 and the coupling protrusion 20a may be provided such that surfaces exposed to the outside through at least the holes 2a have different colors or shapes to allow the stitch line to produce a variety of designs according to the arrangement or the combination of intervals between the fixed protrusions 11 and the coupling protrusions 20a.

The fixed protrusion 11 may be provided to have the same color and texture as the main body 10 in a molding process of the main body 10, and the coupling protrusion 20a may be provided to have a different color or texture from the main body 10, or have a surface shape that is distinguishable from the fixed protrusion 11, in a process of forming the coupling member 22 separately from the main body 10, thereby forming an imitation stitch that is distinguished from the fixed protrusion 11.

The combination of the fixed protrusion 11 and the coupling protrusion 20a forming the stitch line may include a manner in which one combination or a plurality of combinations of the fixed protrusion 11 and the coupling protrusion 20a are alternately arranged along the direction of formation of the stitch line.

Also, a plurality of types of coupling protrusions 20a whose surface exposed to the outside through at least the hole 2a have different colors, textures or shapes may be provided such that another imitation stitches that may be visually distinguished may also be formed between the plurality of coupling protrusions 20a.

In the case of a vehicle interior material where different imitation stitches are formed between the coupling protrusions 20a, not only may regions between the fixed protrusions 11 and the coupling protrusions 20a be visually distinguished, but other types of imitation stitches may be formed on the coupling protrusions 20a, so that the design of the stitch line may be further diversified.

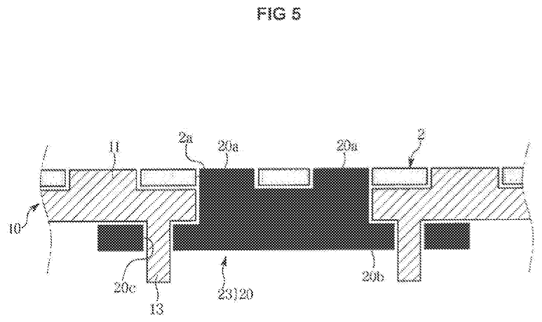

As shown in FIG. 5 illustrating another modified example of the vehicle interior material according to an embodiment, the coupling member 20 may include a third coupling member 23 in which a plurality of coupling protrusions 20a are integrally provided on the support portion 20b.

According to the configuration of the third coupling member 23, because a plurality of imitation stitches may be simultaneously implemented through a process of assembling one of the third coupling member 23 to the main body 10, in diversifying the design of the stitch line, the productivity of the vehicle interior material may be further improved.

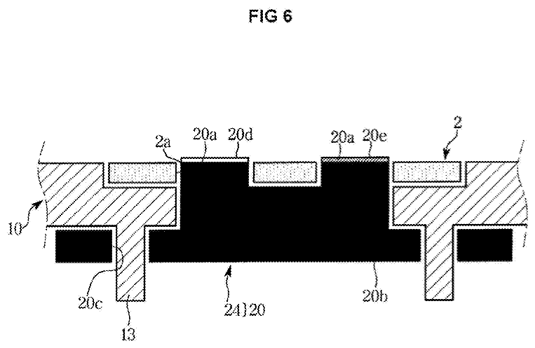

Also, as shown in FIG. 6 illustrating another modified example of the vehicle interior material according to an embodiment, the coupling member 20 may include a fourth coupling member 24 in which at least some of the plurality of coupling protrusions 20a may be provided to differ from each other in color, texture, or shape of surfaces exposed to the outside through the holes 2a.

The fourth coupling member 24 allows visual distinction between the imitation stitches disposed adjacent to each other, so that the fourth coupling member 24 may contribute to diversifying the design of the stitch line as well as increasing the productivity of the vehicle interior material.

The present modified example illustrates that a pair of the coupling protrusions 20a having the same color are integrally formed on the support portion 20b and the pair of coupling protrusions 20 are visually distinguished from each other by the colors of surface layers 20d and 20e formed by the post-processing of the coupling member 24.

The surface layers 20d and 20e may be formed by post-processing the surfaces of the coupling protrusions 20a using a method such as painting, hydraulic transfer, and ion plasma in a state where the fourth coupling member 24 is injection molded.

As is apparent from the above, according to a vehicle interior material having a stitch line according to an embodiment and a method of implementing a stitch line on the vehicle interior material, because a variety of stitch lines can be implemented by selecting a coupling member to be coupled to a main body of a base material in a state where the main body is shared, a design of the stitch line can be variously implemented while a decrease in productivity of the vehicle interior material is suppressed.

What is claimed is:

1. A vehicle interior material comprising:
a base material including a plurality of protrusions on a surface thereof; and
a skin configured to cover the surface of the base material and including a plurality of holes into which the protrusions are fitted to be exposed to the outside in order to form a plurality of imitation stitches,
wherein the plurality of imitation stitches is arranged in a row to form a stitch line, and
wherein the base material includes:
a main body; and
a coupling member coupled to the main body and including at least one of the protrusions.

2. The vehicle interior material according to claim 1, wherein
the coupling member is implemented as a plurality of types such that the protrusions differ from each other in color, texture, or shape of surfaces exposed to the outside through at least the holes.

3. The vehicle interior material according to claim 1, wherein
the protrusions include a fixed protrusion integrally fixed to the main body in a process of molding the main body and a coupling protrusion provided on the coupling member to be coupled to the main body, and
the fixed protrusion and the coupling protrusion are provided to differ from each other in color, texture, or shape of surfaces exposed to the outside through at least the holes.

4. The vehicle interior material according to claim 3, wherein
one combination or a plurality of combinations of the fixed protrusion and the coupling protrusion is alternately arranged along a forming direction of the stitch line.

5. The vehicle interior material according to claim 3, wherein
the coupling protrusion is implemented as a plurality of types to differ from each other in color, texture, or shape of surfaces exposed to the outside through at least the holes.

6. The vehicle interior material according to claim 3, wherein
the coupling member further includes a support portion to support the coupling protrusion, and
the plurality of coupling protrusions is integrally provided on the support portion.

7. The vehicle interior material according to claim 6, wherein
at least some of the plurality of coupling protrusions provided on the support portion are provided to differ from each other in color, texture, or shape of surfaces exposed to the outside through at least the holes.

8. The vehicle interior material according to claim 1, wherein
the main body is provided with a mounting hole formed to communicate with the hole,
the coupling member includes a support portion provided to be caught around the mounting hole to support the protrusion such that the protrusion is sequentially coupled to the mounting hole and the hole in a direction from a back surface to a front surface of the main body, and
the mounting hole is filled by the protrusion.

9. A method of implementing a stitch line on a vehicle interior material in which a skin is coupled to a surface of a base material, which comprises:
providing a plurality of protrusions on the surface of the base material;
providing a plurality of holes, into which the protrusions are fitted to be exposed to the outside in order to form imitation stitches, on the skin; and
forming the stitch line through an arrangement of a plurality of the imitation stitches by coupling the skin to the surface of the base material such that the plurality of protrusions is fitted to the plurality of holes,
wherein the base material includes:
a main body; and
a coupling member coupled to the main body and including at least one of the protrusions,
wherein the protrusions include:
a fixed protrusion integrally fixed to the main body in a process of molding the main body; and
a coupling protrusion provided on the coupling member to be coupled to the main body,
wherein the coupling member is implemented as a plurality of types such that the protrusions differ from each other in color, texture, or shape of surfaces exposed to the outside through at least the holes, and
wherein the types of the coupling members coupled to the main body in a state in which the main body is shared are applied differently to implement the stitch lines having a different design.
